(19) United States
(12) Patent Application Publication
(10) Pub. No.: US 2021/0168611 A1
(43) Pub. Date: Jun. 3, 2021

(54) METHOD FOR SECURELY SHARING A URL

(71) Applicant: Diego MATUTE, Kanata (CA)

(72) Inventor: Diego MATUTE, Kanata (CA)

(21) Appl. No.: 17/170,499

(22) Filed: Feb. 8, 2021

Related U.S. Application Data
(63) Continuation of application No. 14/295,904, filed on Jun. 4, 2014, now abandoned.
(60) Provisional application No. 61/830,805, filed on Jun. 4, 2013.

(51) Int. Cl. H04W 12/08; H04W 12/06; H04L 29/08; H04W 12/43; H04L 29/06; H04W 12/61

(52) U.S. Cl. CPC H04W 12/08; H04W 12/06; H04L 67/26; H04L 63/108; H04L 63/0823; H04W 12/61; H04W 12/43

(57) ABSTRACT

A method is disclosed wherein a URL is associated with a resource. The URL is for use in accessing the resource. A smartphone is associated with a recipient. The URL is provided to the recipient. When the URL is accessed by a request for access to the resource relying upon the URL, transmitting from a server to the smartphone a push notification. When the push notification is responded to, allowing access to the resource via the communications network in dependence upon the response.

### CROSS-REFERENCE TO RELATED APPLICATIONS

This patent application is a continuation of U.S. patent application Ser. No. 14/295,904 filed Jun. 4, 2014 which claims the benefit of U.S. Provisional Patent Application 61/830,805 filed Jun. 4, 2013 entitled “A Method For Securely Sharing a URL”, the contents of which are herein incorporated by reference.

### FIELD OF INVENTION

The invention relates to information sharing and more particularly to authenticated information sharing.

### BACKGROUND

Sharing of information has become both commonplace and simple. With the click of a button, users can now share Tweets, URLs, files, and more. This allows users to rely on the Internet as a communication tool for conversation.

### SUMMARY OF EMBODIMENTS OF THE INVENTION

In accordance with the invention there is provided a method comprising associating a URL and a resource, the URL for accessing the resource; associating a smartphone with a recipient; providing from a first user to a recipient the URL; receiving a request for access to the resource relying upon the URL, the request received via a communication network; upon receiving the request for access to the resource, transmitting from a server to the smartphone a push notification; receiving a reply based on the push notification transmitted to the smartphone; and in dependence upon the reply, allowing access to the resource via the communications network.

### BRIEF DESCRIPTION OF FIGURES

FIG. 1 shows a simplified block diagram of a wide area computer communication network.

FIG. 2 shows a simplified flow diagram of a prior art method of file sharing information via a communication network.

FIG. 3 shows a simplified system for sharing a URL wherein the URL is associated with a verification process.

FIG. 4 shows a simplified system for sharing a URL wherein the URL is associated with a security process for establishing the user identification prior to providing access to a resource.

FIG. 5 shows a simplified system for sharing a URL wherein the URL is associated with a verification process.

FIG. 6 shows a simplified system for sharing a URL wherein access to the URL resource is allowed only during specific times.

FIG. 7 shows a simplified system for sharing a URL wherein a URL shortening service server polices the access to a URL.

FIG. 8 shows a simplified system for sharing a URL wherein a file hosting service polices access to the URL resource.

### DETAILED DESCRIPTION OF EMBODIMENTS

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

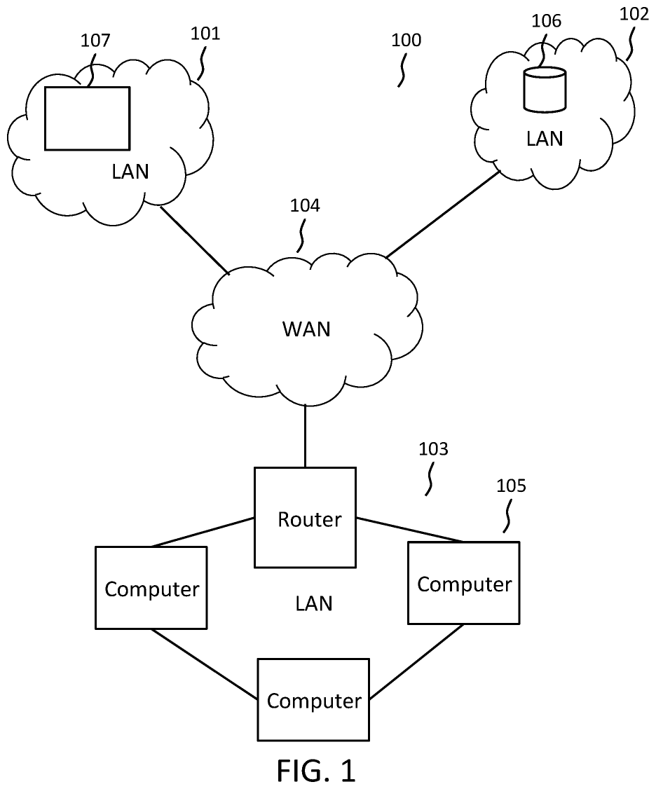

Referring to FIG. 1, shown is a simplified block diagram of a wide area computer communication network 100. Local area networks (LANs) 101, 102 and 103 are interconnected via wide area network (WAN) 104.

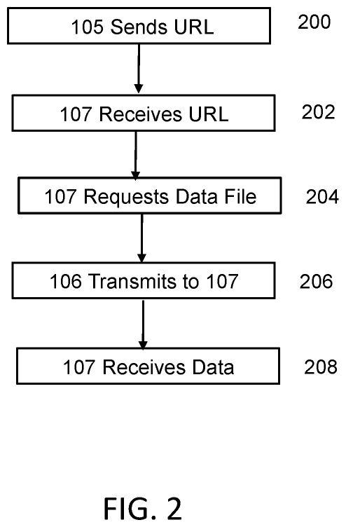

Shown in FIG. 2 is a simplified flow diagram of a prior art method of file sharing information via the network 100. At 200 a user sends a URL of a data file from computer 105 to a recipient using computer 107, via WAN 104. The URL is sent, for example in an email to the recipient. At 202 the recipient selects the URL within the email and a request is sent from computer 107 in LAN 101 to server 106, in LAN 102, requesting access to the data file at 204. Server 106 transmits the data file to computer 107 for the recipient to view 206. At 208 the recipient views the data file on the screen of computer 107. In accordance with this method, a file may be “protected” from intentional access by an unauthorized user by making the URL arbitrary, long and/or complex-obfuscating the data file address. However, by executing a script trying various combinations of URLs until any data file is found, obfuscated files can be identified and accessed; as such, they are not secure.

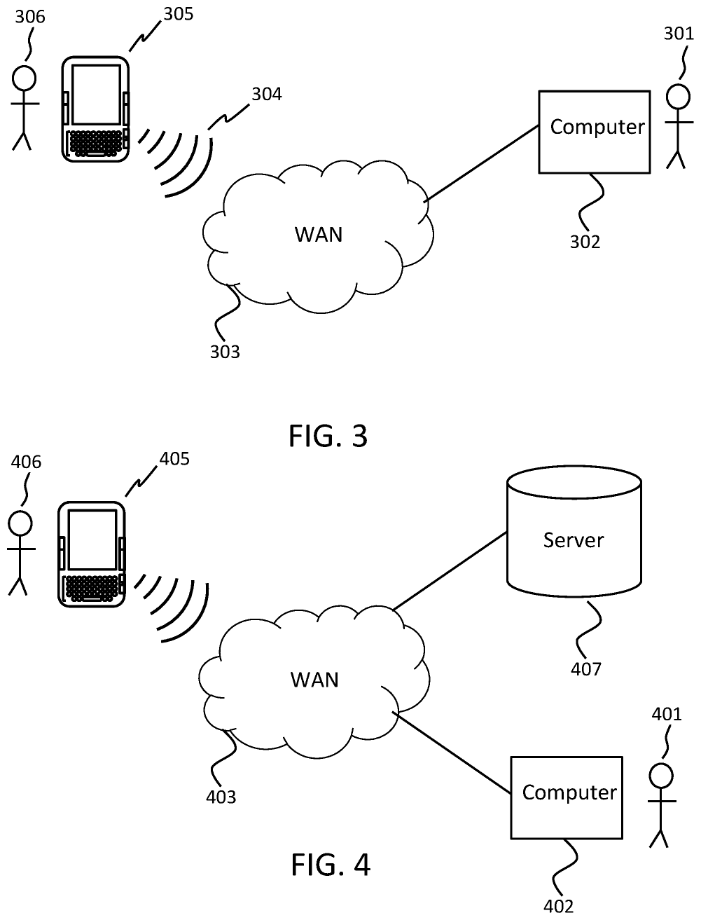

Shown in FIG. 3, is a simplified system for sharing a URL according to an embodiment. A user 301 selects data in the form of a website addressable by a given URL, to be shared with recipient 306. User 301 sends recipient 306 from the user system 302 the URL of the website or, alternatively, a URL for being forwarded to the URL of the website. Sending the URL is accomplished through any of a number mechanisms including but not limited to email, text message, verbal communication, written or printed communication, tweeting, etc. Upon receipt of the transmitted URL, recipient 306 tries to access the URL resource. The URL is associated with a security process such that upon an attempt to access the URL resource, verification of the person attempting to access the URL resources is sought via another channel other than the URL. For example, a message is provided to a mobile computing device or a smart phone of at least one of the sender and the recipient of the URL. An example of such a message is a push notification to a security application within the mobile communication device. Provided that the verification requisites are met—recipient responds to the verification request correctly, recipient 306 is provided access to the website.

Now referring to FIG. 4, shown is a simplified diagram of a system for sharing a URL or a resource accessible via a URL. In this example a URL is associated with a security process for establishing user identification prior to providing access to the resource. User 401 selects a resource in the form of a data file to share with recipient 406. User 401 sends recipient 406 the URL, for example from the user system 402, by way of electronic message via WAN 403 in the form of the Internet. For the purposes of security, the data recipient 406 is uniquely associated with smartphone 405. Upon receipt of a message comprising the URL or an indication thereof, recipient 406 tries to access the URL resource. When the attempt to access the URL resource is made, server 407 sends an electronic message in the form of a push notification to smartphone 405. In this example, the verification process is such that recipient 406 is requested to reply to the message received at smartphone 405. When the verification process is complete by recipient 406 successfully replying to the message, recipient 406 is provided access to the resource. Sending the electronic message to smartphone 405 adds a level of security to accessing the data file. Alternatively, further verification processes including requesting the recipient 406 to enter a password or other authentication information are employed in conjunction with the push notification process in order to secure against a lost or stolen smartphone. In a specific example, the URL is associated with a recipient. The user 401 tweets the URL indicating that it is intended for the recipient and many people receive and can access the URL. As a result multiple recipients attempt to access the data file; however, only recipient 406 receives the push notification and is verified by the security process. Other users are prevented from accessing the URL contents.

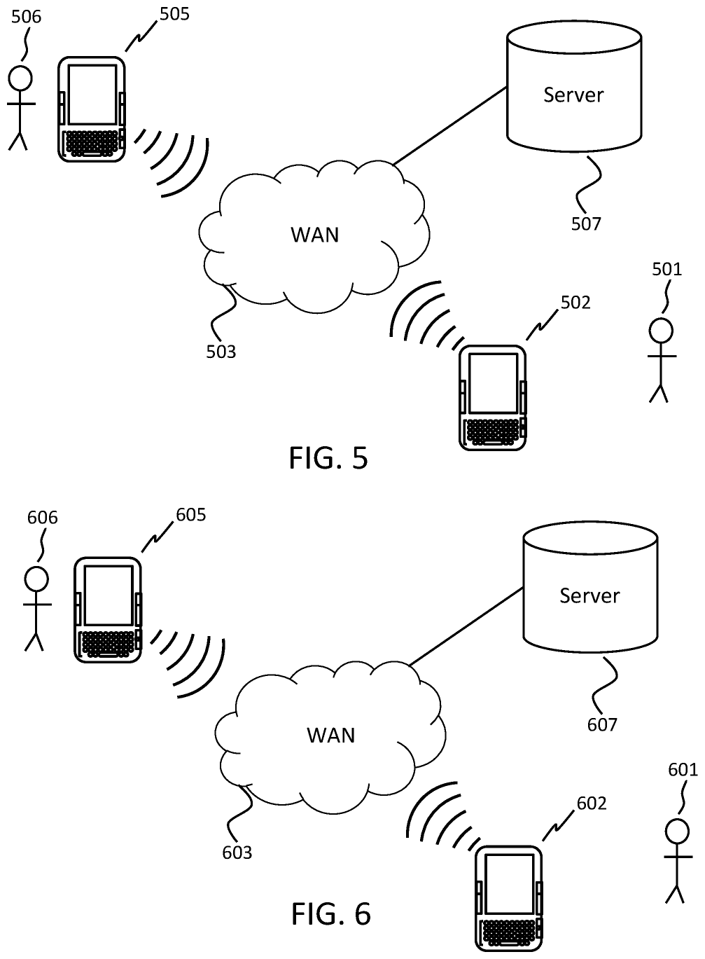

Shown in to FIG. 5, is another embodiment of a simplified system for sharing a URL. A WAN 503 in the form of the Internet couples a plurality of communication devices for communication therebetween. User 501 selects data in the form of a data file to be shared with recipient 506. The data file is associated with a URL; for example, it is a page on the World Wide Web. User 501 sends recipient 506 the URL from the user system 502. The URL could be communicated via email, text message, or even verbally or in print. For the purposes of security, the data file URL is associated with a sender. For example, the user 501 is uniquely associated with smartphone 502. The data file URL is associated with the user 501. Upon receipt of the text message, recipient 506 tries to access the URL resource. When the attempt to access the URL resource is made, server 507 sends a push notification to smartphone 502. In this example, the verification process is such that user 501 is requested to reply to a push notification from smartphone 502. When the verification process is complete by user 501 successfully sending the text message, recipient 506 is allowed to access to the data file. Sending the push message to smartphone 502 adds a level of security to accessing the data file assuming of course recipient 501 has not lost smartphone 502 or it has not been stolen. Here, user 501 reasonably assumes that it is recipient 506 who is trying to access the URL. Alternatively, other verification processes are also used. Further optionally, user 506 is messaged instead of user 501 or in conjunction with user 501.

Now referring to FIG. 6, shown is another system for sharing a URL. In this example a URL is associated with a security process for establishing user identification prior to providing access to data wherein the security process allows access to the URL resource only during specific times. User 601 selects data, a specific and non-limiting example is a data file, to be shared with a recipient 606. User 601 sends recipient 606 the URL from the user system 602 in the form of, for example, an electronic message via WAN 603 in the form of the Internet. For the purposes of security, the URL is associated with a verification process. For example, recipient 606 is uniquely associated with smartphone 605 as is the security process. The URL is therefore associated with smartphone 605. The URL is further associated with time periods during which access is supported. Upon receipt of the electronic message, recipient 606 tries to access the URL resource. When the attempt to access the URL is made, server 607 sends a push notification to smartphone 605. If the time is not in the allowable time slot for accessing the data file a push notification is sent indicating to recipient 606 that access is denied. Recipient 606 will have to try to access the data file another time. However if the time is in an allowable time slot for accessing the data file the recipient 606 is requested to reply to the electronic message from smartphone 605. When the verification process is complete by recipient 606, recipient 606 is provided access to the data file. Sending the push notification to smartphone 605 adds a level of security to accessing the data. Alternatively, other verification processes including requesting the recipient 606 to enter a password or other authentication information are used in conjunction with the push notification.

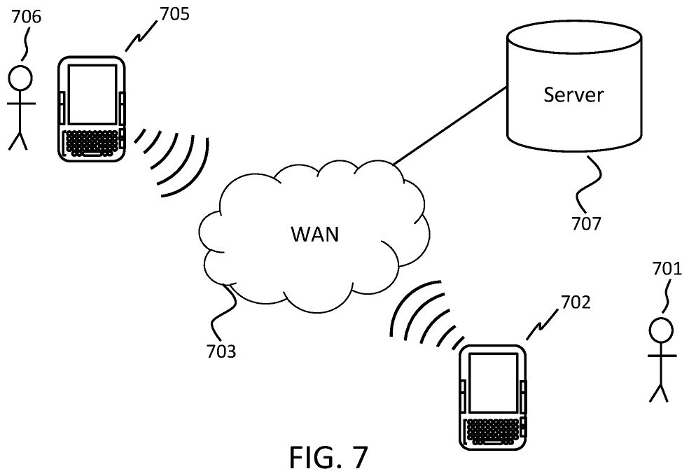

Now referring to FIG. 7, shown is another embodiment wherein a URL shortening service secures access to a URL. User 701 selects data in the form of a data file to be shared with a recipient 706. User 701 transmits from the user system 702 an electronic message via WAN 703 in the form of the Internet to recipient 706 a shortened URL provided by a URL shortening service. For the purposes of security, the shortened URL is associated with a verification process. Recipient 706 is associated with smartphone 705. The shortened URL is intended for recipient 706 and, as such, is also associated with smartphone 705. Upon accessing the URL via the shortened URL, the URL shortening service server 707 transmits or requests transmission of a push notification to smartphone 705. Thus, a push notification is transmitted to the recipient 706. The push notification requests or motivates a response from the recipient 706. In this example, the verification process is such that recipient 706 is requested to send a response message from smartphone 705 including a passcode. URL shortening service server verifies that the response was provided before the full URL is provided by server 707 allowing access to the URL. When the verification process is completed by recipient 706 sending the reply message, recipient 706 is provided access to the full URL and its contents. Sending the push notification to smartphone 705 adds a level of security to accessing the URL. Alternatively, other verification processes include the requesting the recipient 706 to enter a password or other authentication information. Alternatively, the recipient 706 need only reply to the push notification to access the URL.

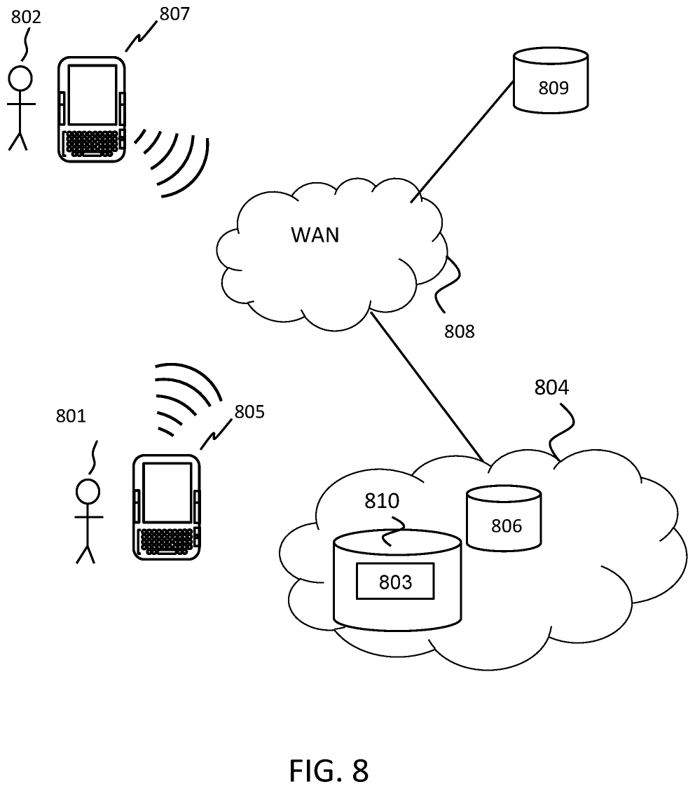

Shown in FIG. 8 is yet another embodiment wherein a cloud file-storage service polices access to file data. User 801 intends to share a file with recipient 802. There are many known methods of doing this, but one that is now popular is storing the file within a cloud storage medium and assigning to the file a URL. Upon entering the URL, the file is either displayed or viewed. As noted above, such a methodology leaves the file open to random searches through potential URLs.

As shown in FIG. 8, recipient 802 has an application on smartphone 807 for providing file sharing security. Such an application is included within a cloud sharing application such as the DropBox® iPhone® application. Alternatively, such an application is integrated within the mobile communication device. Further alternatively, such an application is a separate security application. Of course further variants of the application type are also supported.

Once the application is installed in the mobile communication device of recipient 802, the application is registered with server 809. During the registration process, the application is uniquely identified. Such a registration process is well known, for example for supporting push notification. Now the recipient 802 is uniquely associated with mobile communication device in the form of smartphone 807 and the application in execution thereon. User 801 uses a cloud file hosting service such as Dropbox® for securely storing files and sharing files and/or directories with others. In this example, user 801 wishes to share a file with recipient 802, the file being stored in Dropbox® cloud storage 804 of User 801. User 801 transmits a URL relating to data file 803 to recipient 802 via WAN 808 in the form of the Internet. However, when the recipient 803 selects the URL to gain access to data file 803, the Dropbox® security server 806 transmits or requests a push notification to the application running on smartphone 807. Because the recipient is known, the application of the recipient is uniquely addressed with the push notification. In response, recipient 802 responds via the application to unlock the data file within the cloud storage. Since the smartphone 807 is known to be that of the recipient 802, only the recipient can unlock the file. Others using the same URL will not get access to the file. Of course, a further password or code is optionally required to limit access to someone who possesses the smartphone 807 and specific knowledge.

When the verification process is completed Dropbox® security server 806 allows recipient 802 to gain access to file 803. Sending the push message to smartphone 807 and receiving a response from the registered application adds a level of security to accessing the data file 803.

In an alternative embodiment, a single URL is associated with a plurality of recipients. The recipients only respond to the push notification when they are accessing the URL or file, and as such, though the push notification is transmitted to several mobile communication devices, typically only one responds.

Alternatively, one URL is associated with a plurality of recipients. Upon accessing the URL, a recipient is asked for an identification in the form of a username. Each username is associated with a smartphone application and, as such, once the username is entered by a recipient the smartphone receives a push notification for the smartphone application of a user associated with the username. Thus, a recipient provides a URL, a username, and verification of the push notification in order to access the URL or the file.

In an embodiment, only one URL is associated with each recipient and only one recipient is associated with each URL. One process for ensuring this is to use a URL translator such as a URL shortener that results in a URL different from the address of the accessed data, but unique thereto. In such an embodiment, each URL translation code links a URL and a recipient in a unique fashion so that providing the URL translation code, itself a URL, results in a security process for the recipient and for unlocking the destination URL. Advantageously, the URL translation code would not necessarily indicate the final URL of the data file. Further, the URL translator service, when not local to the URL, optionally supports a security protocol with the URL host to ensure that the URL is only accessed securely.

Along with the push notification you can use other forms of authorization either at the mobile communication device, at the initiating system or both to identify the user engaged in the transaction.

Numerous other embodiments may be envisaged with out departing from the scope of the invention

1-20. (canceled)

21. A method comprising:
associating a smartphone with a recipient;
associating a URL and a resource and the recipient, the URL for accessing the resource when authorised by the recipient;
providing from a first user to the recipient the URL;
receiving a request for access to the resource relying upon the URL, the request received via a communication network;
upon receiving the request for access to the resource, transmitting a push notification from a server to the smartphone associated with the recipient associated with the URL;
receiving a reply based on the push notification transmitted to the smartphone; and
in dependence upon the reply, allowing access to the resource via the communications network.

22. A method according to claim 21 wherein providing from a first user to the recipient the URL comprises transmitting the URL from a first user system to the recipient via the communications network.

23. A method according to claim 22 wherein the reply comprises a reply to the push notification received from the smartphone via the communication network.

24. A method according to claim 23 wherein the smartphone is uniquely associated with the recipient and the URL is uniquely associated with the recipient.

25. A method according to claim 23 wherein the smartphone is uniquely associated with the recipient and the resource is uniquely associated with the recipient.

26. A method according to claim 24 wherein the smartphone comprises, installed thereon, an application for receiving push notifications.

27. A method according to claim 26 wherein providing a reply comprises responding from within the application, the response transmitted to a server from the smartphone.

28. A method according to claim 27 wherein transmitting a reply from the smartphone comprises transmitting a certificate between the application and the server.

29. A method according to claim 27 comprising:
from within the application, receiving authentication data provided by a user; and
wherein providing a reply comprises transmitting a response to a server from the smartphone based on the authentication data.

30. A method according to claim 21 wherein the URL is associated with a plurality of recipients and,
wherein transmitting the push notification is performed for each of the associated recipients when the request for access is received; and
wherein allowing access to the resource via the communications network comprises allowing access to the resource only when a reply is received from more than one of the associated recipients.

31. A method according to claim 21 comprising:
determining a time of the request and restricting access to the resource at some times; and
allowing access to the resource at other times.

32. A method according to claim 21 further comprising transmitting a push notification to the smartphone indicating access to the resource has been denied.

33. A method according to claim 21 wherein the URL is a URL for being directed to the first URL by a URL directing service.

34. A method according to claim 33 wherein the URL directing service comprises a URL security service.

35. A method according to claim 33 wherein the URL directing service comprises a cloud-based file-sharing service.

36. A method according to claim 35 wherein the resource is at least one of a webpage, a second URL, and data.

37. A method according to claim 21 wherein providing from a first user to the recipient the URL comprises sending the URL in one of an email, text, and tweet.

38. A method according to claim 21 wherein receiving a reply comprises receiving authentication data for authenticating a source of the reply.

39. A method comprising:
associating a smartphone with a recipient;
associating a URL and a resource, the URL for accessing the resource;
providing from a first user to the recipient the URL;
receiving a request for access to the resource relying upon the URL, the request received via a communication network;
in response to receiving a request to access the URL providing a request for a user identification; receiving from a user, user identification;
transmitting a push notification to the smartphone associated with the provided user identification; and
receiving a reply based on the push notification transmitted to the smartphone; and
in dependence upon the reply, allowing access to the resource via the communications network.

40. A method comprising:
associating a smartphone with a recipient;
associating a URL and a resource and the recipient, the URL for accessing the resource when authorised by the recipient;
providing from a first user to the recipient the URL;
receiving a request for access to the resource relying upon the URL, the request received via a communication network;
upon receiving the request for access to the resource, and without responding thereto with either the resource or an access page, transmitting a push notification from a server to the smartphone associated with the recipient associated with the URL;
receiving a reply based on the push notification transmitted to the smartphone, the reply received from the smartphone; and
in dependence upon the reply, performing one of denying access to the resource and providing access to the resource via the communications network.

41. A method comprising:
associating a smartphone with a recipient;
associating a URL and a resource and the recipient, the URL for accessing the resource when authorised by the recipient;
providing from a first user to the recipient the URL;
receiving a request for access to the resource relying upon the URL, the request received via a communication network;
upon receiving the request for access to the resource, and without responding thereto with either the resource or an access page, transmitting a push notification from a server to the smartphone associated with the recipient associated with the URL;
receiving a reply based on the push notification transmitted to the smartphone, the reply received from the smartphone;
when the reply is indicative of an authorised access, based on the URL, performing one of directing the user to the resource and retrieving the resource and providing it to the user for access thereto via the communication network; and
when the reply is indicative of an unauthorised access, denying access to the resource.
